(19) United States
(12) Patent Application Publication
(10) Pub. No.: US 2024/0308224 A1
(43) Pub. Date: Sep. 19, 2024

(54) METHOD FOR ANALYZING A PRINT HEAD

(71) Applicant: Ivoclar Vivadent AG, Schaan (LI)

(72) Inventors: Nicola Bitar, Montlingen (CH); Jonas Reinhardt, Igis (CH); Christian Niedrig, Azmoos (CH); Johannes Renner, Ostermundigen (CH)

(21) Appl. No.: 18/599,124

(22) Filed: Mar. 7, 2024

(30) Foreign Application Priority Data
Mar. 14, 2023 (EP) 23161778.8

(51) Int. Cl. B41J 2/165; G01D 21/02

(52) U.S. Cl. CPC B41J 2/16579; G01D 21/02

(57) ABSTRACT

A method for analyzing a print head (103), including the steps of driving (S101) a piezo element within the print head with a sequence of voltage profiles; and detecting (S102) a sound level, a current flow, a resistance, an impedance, and/or a temperature of the print head during the driving.

### CROSS-REFERENCE TO RELATED APPLICATIONS

This application claims priority to EP 23161778.8, filed on Mar. 14, 2023, the disclosure of which is incorporated herein by reference in its entirety.

### TECHNICAL FIELD

The present invention relates to a method for analyzing a print head and a printing device for performing the method.

### BACKGROUND

U.S. Pat. No. 5,646,654, 20040017412, 20120287186, 20130215172, and 20180009229 are directed to printing technology and are hereby incorporated by reference in their entirety.

### SUMMARY

It is the technical task of the present invention to detect the condition of a print head or a printing liquid in a printing device.

This task is solved by subject matter according to the independent claims. Technically advantageous embodiments are the subject matter of the dependent claims, the description and the drawings.

According to a first aspect, the technical task is solved by a method for analyzing a print head, comprising the steps of driving a piezo element within the print head with a sequence of voltage profiles; and detecting a sound level, a current flow, a resistance, an impedance, and/or a temperature of the print head during the driving. For example, the current flow is the averaged electric current value over a voltage profile. By driving the piezo elements and simultaneously measuring (sensing) the power consumption or the acoustics, parameters of the print head and the fluid system can be determined, such as a reactance, an aging of the print head. In addition, a flow rate through the print head, a viscosity of the liquid in the print head or an aging or change of the printing liquid, or a detachment of the nozzle plate can be determined.

In a technically advantageous embodiment of the method, a malfunction of the printing nozzle is detected when the detected sound level, the current flow or the temperature is above a predetermined value. This provides the technical advantage, for example, that a malfunction caused by, for example, a blockage, air pockets in the liquid, a compression of the liquid or a particle buildup in the nozzle channel can be detected without printing and in a simple manner.

In another technically advantageous embodiment of the method, the piezo element is excited over a predetermined period of time. This provides the technical advantage, for example, of increasing the reproducibility of the measurement by averaging the measurement signal over time and obtaining a meaningful measurement even with a lower resolution of the measurement system. The piezo element can be driven with a predetermined voltage profile.

In another technically advantageous embodiment of the method, the sequence of voltage profiles comprises a predetermined sequence of voltage profiles different from one another. This provides the technical advantage, for example, that a characteristic course is obtained as a function of different voltage profiles, so that an increased sensitivity of the measurement is achieved. This makes it possible to characterize different components.

In another technically advantageous embodiment of the method, a hold time, rise time and/or fall time of the voltage profiles increases or decreases in sequence. This provides the technical advantage, for example, that a printing liquid can be characterized on the basis of a speed of sound or other parameters. In addition, a viscosity or change in particle concentration can be determined.

In another technically advantageous embodiment of the method, a course of the current flow or the temperature of the print head is detected during the driving. This provides the technical advantage, for example, that the detected course can be compared with a predetermined course of the current flow or the temperature. Due to the energy input of the piezo elements, a temperature-related change can be detected by a temperature sensor or a flow rate because of a temperature-related change.

In another technically advantageous embodiment of the method, the detected course is compared with a pre-stored course. This provides the technical advantage, for example, that a deviation can be determined. In the case of a small deviation from a pre-stored course, a property associated with the pre-stored course can be inferred, such as a flow rate or aging.

In another technically advantageous embodiment of the method, the type of a printing liquid inside the print head is determined or characterized on the basis of the comparison. This provides the technical advantage, for example, that a presence of a specific printing liquid can be determined. As a result, process reliability can be increased and it is possible to verify whether the desired liquid is in the system or whether this liquid is functional.

In another technically advantageous embodiment of the method, the sequence of voltage profiles comprises a predetermined sequence of voltage profiles equal to one another. This provides the technical advantage, for example, that more accurate measurement results can be obtained because averaging can be performed over a plurality of voltage profiles.

In another technically advantageous embodiment of the method, detachment of a nozzle plate is detected when the current flow falls below a predetermined value. This provides the technical advantage, for example, that damage to the printing device can be detected, such as a defective nozzle plate or microfluidics or defective print heads that are delaminated internally.

In another technically advantageous embodiment of the method, wear of the piezo element is detected when the detected sound level or the current flow falls below a predetermined value.

This provides the technical advantage, for example, that aging of the print head can be detected.

In another technically advantageous embodiment of the method, the method is performed when the printing liquid in the print head is changed. This provides the technical advantage, for example, of determining whether the new printing liquid has arrived completely in the print head or whether the intended printing liquid has been filled in. In addition, an increase in efficiency can be realized.

In another technically advantageous embodiment of the method, the printing nozzle is open or closed during the method. This provides the technical advantage, for example, that the method can be performed with different opening positions of the printing nozzle.

In another technically advantageous embodiment of the method, the print head is covered by a closure plate. This provides the technical advantage, for example, that no printing liquid is lost during the method.

According to a second aspect, the technical task is solved by a printing device which is configured to carry out the method according to the first aspect. The printing device achieves the same technical advantages as the method according to the first aspect.

### BRIEF DESCRIPTION OF THE DRAWINGS

Exemplary embodiments of the invention are shown in the drawings and are described in more detail below, in which:

FIG. 1 shows a schematic cross-sectional view of a controllable print head;

FIG. 2 shows a schematic view of a voltage profile for driving a piezo element;

FIG. 3 shows courses of the current flow as a function of voltage profiles for different printing liquids;

FIG. 4 shows further courses of the current flow as a function of voltage profiles for different printing liquids;

FIG. 5 shows courses of the sound level as a function of voltage profiles for different flow rates;

FIG. 6 shows a schematic view of a closure plate for the print head; and

FIG. 7 shows a block diagram of a method for analyzing a print head.

### DETAILED DESCRIPTION

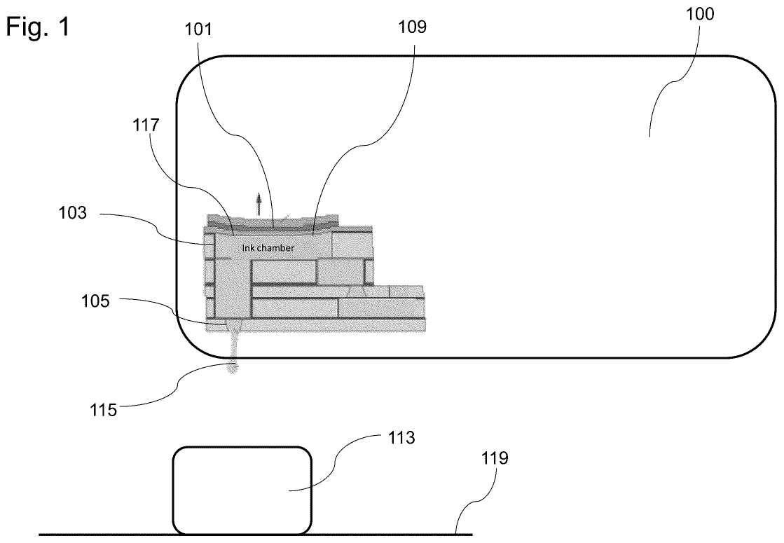

FIG. 1 shows a schematic cross-sectional view of a controllable print head 103 of a printing device 100. The printing device 100 uses a jet of liquid drops 115 for a printing process (inkjet process). The printing process may be a two-dimensional printing process for creating images by applying ink, or a three-dimensional printing process for creating spatial objects 113 created by a printing liquid 109 accumulated layer by layer on a building platform 119.

For ejecting the printing liquid 109, at least one piezo element 101 is installed in the print head 103 of the printing device 100, which converts an electric voltage pulse into a movement and transfers it to the printing liquid 109 in the ink chamber 117. The movement of the piezo element 101 is achieved by the inverse piezo effect, which causes the piezo element 101 to produce a downward movement (fall) when a negative voltage is applied and an upward movement (rise) when a positive voltage is applied.

A voltage profile is used to drive the piezo elements 101, which has different sections. Depending on the voltage profile and the printing liquid 109 used, differently formed liquid drops 115 are created.

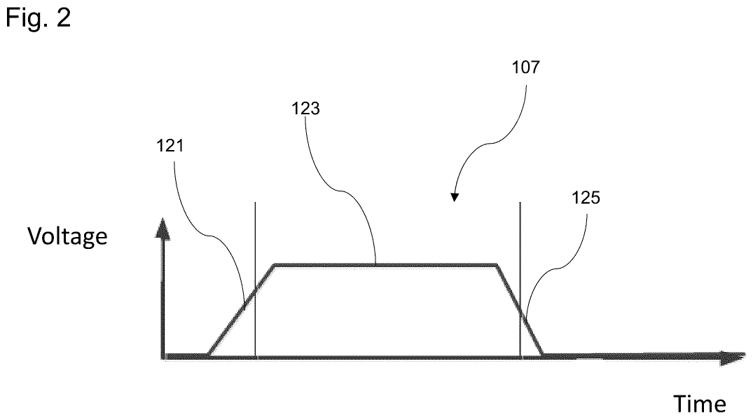

FIG. 2 shows a schematic view of a trapezoidal voltage profile 107 for driving the piezo element 101. The voltage profile 107 is generated by an electronic control unit with an electrical circuit and may be stored as a previously predetermined voltage profile 107 in the printing device 100. For this purpose, the data of the voltage profile 107 may be digitally stored in the control unit and modified. The control unit may also store a plurality of predetermined voltage profiles 107, one of which is selected as the starting point for the method depending on the printing liquid used.

The voltage profile 107 comprises three sections, namely a first start section 121 with a fall time in which the electric voltage rises, a second hold section 123 with a waiting time in which the electric voltage is constant, and a third end section 125 with a rise time in which the electric voltage falls. To create a suitable drop shape, the respective sections 121, 123 and 125 are changed.

In this process, the fall time, waiting time and rise time of the respective sections 121, 123 and 125 are changed and adjusted. Since each printing liquid 109 is rheologically different, a correspondingly adjusted voltage profile 107 should be used for the printing process for each printing liquid 109. If the printing liquid comprises particles, the filling degree or the solids concentration can also be determined.

The fall time generates a pulling motion of the piezo element 103. The start section 121 is composed of the fall time and a drop-out voltage. The drop-out voltage, for example, has an influence on the generated drop size. If the drop-out voltage changes greatly, the speed of sound of the printing liquid 109 should not be exceeded.

The waiting time is the time at a constant voltage in the hold section 123 during which the printing liquid 109 relaxes. The relaxation is related to the speed of sound within the printing liquid 109. The end of the waiting time should coincide as closely as possible with the relaxation of the printing liquid 109 in the ink chamber 117 of the print head 103, so that at this time the rise time starts synchronously with the relaxation movement. With an optimum synchronous setting, the least energy is thus required to eject a drop thereafter.

The rise time in the end section 125 generates a pushing motion of the piezo element 101. The motion of the printing liquid 109 generated by the fall time and the relaxation of the printing liquid 109 generated in the waiting time is further accelerated during the rise time, so that a liquid drop 115 escapes from the ink chamber 117 through the printing nozzle 105.

The amplitude height is the height of the electric voltage during the waiting time and correlates with the height of the ejected liquid drop 115. When tuning the voltage profile 107, a constant predetermined voltage can be used as the amplitude height corresponding to the displacement of the piezo element 101.

When tuning the voltage profile 107 (wave tuning), different voltage profiles 107 with different fall time, waiting time, rise time and amplitude height are generated. Then, for the individual voltage profiles 107, the electric current through the piezo element 101 is determined with an ampere meter (ammeter) or a suitable electrical circuit and averaged over the duration of the voltage profile 107, for example by integrating individual current values over time. The voltage profile 107 may be repeatedly applied to the piezo element 101 at a repetition frequency to average the electric current through the piezo element 101 during that duration.

Instead of the electric current through the piezo element 101, the sound amplitude generated by the piezo element 101 can also be used. The electric current or sound amplitude values thus detected are then used to select one of the generated voltage profiles 107.

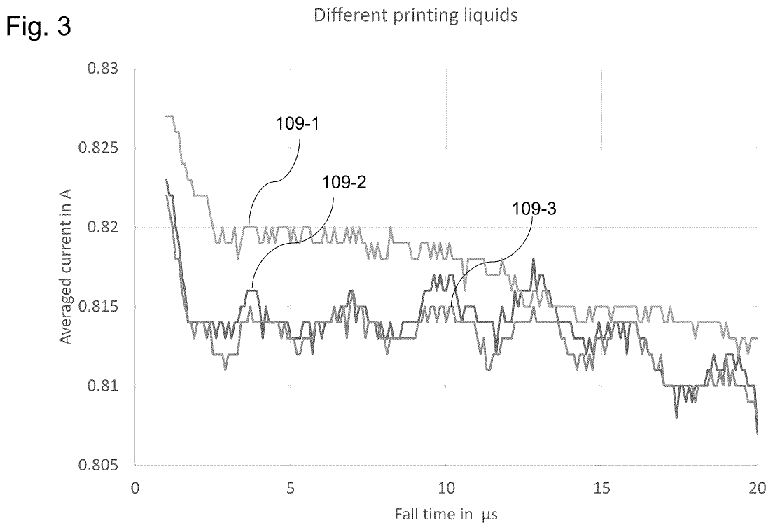

FIG. 3 shows courses for different printing liquids 109-1, 109-2, and 109-3 within the print head 103, where an average detected current value is plotted with varying fall time of the voltage profile 107. The voltage profiles 107 used have a constant waiting time of 2.3 us and a constant rise time of 1 μs. The repetition rate of the voltage profiles is 15 kHz. The voltage profiles can also be repeated at another specific frequency, which is also adjustable.

The fall time of the voltage profile 107, on the other hand, is changed between 1 us and 20 μs (X axis). Here, a predetermined voltage profile is used whose fall time is increased in small steps from the minimum value to the maximum value. At each fall time, the respective associated average current value flowing through the piezo element 101 is detected (Y-axis). Alternatively, the sound level can also be determined with a microphone.

Each of the printing liquids 109-1, 109-2, and 109-3 has a different characteristic course. For example, if the detected course for one of the printing liquids 109-1, 109-2 and 109-3 is compared to a pre-stored course for the printing liquid 109-1, 109-2 and 109-3, it can be determined which printing liquid is in the print head 103. In this method, the print head 103 and its printing nozzles 105 are closed. Thus, it is not possible for the printing liquid 109 to escape through the printing nozzles 105.

By subsequently driving with different voltage profiles 107, many parameters can be determined by means of a current and sound measurement, for example of the printing liquid, the printing system and the condition of the print head. However, with closed printing nozzles 105 and excited piezo elements 101, other parameters of the printing liquid 109, fluid properties, or a condition of the print head can also be determined. The measurement can be performed with closed or covered printing nozzles 105, or with open printing nozzles 105 during printing. With the print head closed, the advantage is that no ink is wasted.

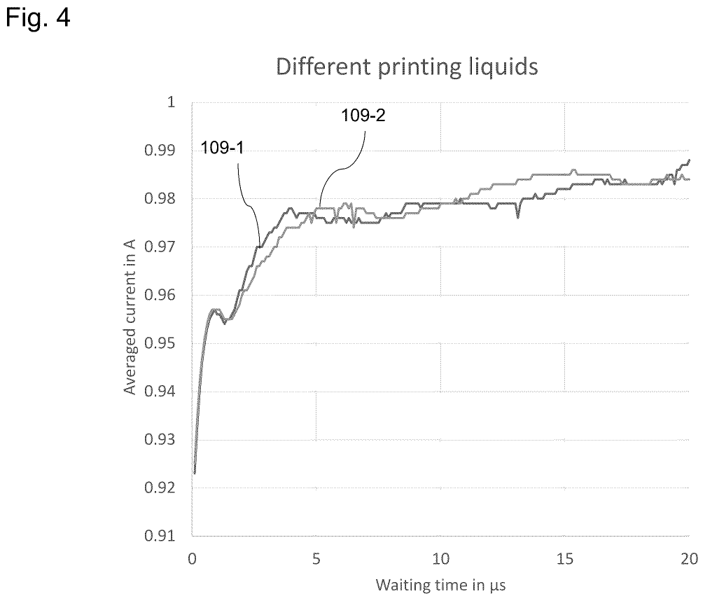

FIG. 4 shows further courses for different printing liquids 109-1 and 109-2 within the print head 103, where an average detected current value for the current flow is plotted for varying waiting time of the voltage profile 107. The voltage profiles 107 used have a constant fall time of 2.3 μs and a constant rise time of 1 μs. The repetition rate is 20 KHz.

The waiting time of the voltage profile 107, on the other hand, is changed between 1 μs and 20 μs (X axis). Here, a predetermined voltage profile 107 is used, whose waiting time is increased in small steps from the minimum value to the maximum value. For each waiting time, the respective associated average current value for the current flow, which flows through the piezo element 101, is detected (Y-axis).

Alternatively, the sound level can also be determined with a microphone.

Each of the printing liquids 109-1 and 109-2 has a different characteristic course. For example, if the detected course for one of the printing liquids 109-1 and 109-2 is compared to a pre-stored course for the printing liquid 109-1 or 109-2, it can be determined which printing liquid is in the print head 103. In this method, the print head 103 and its printing nozzles 105 are closed. Thus, it is not possible for the printing liquid 109 to escape through the printing nozzles 105.

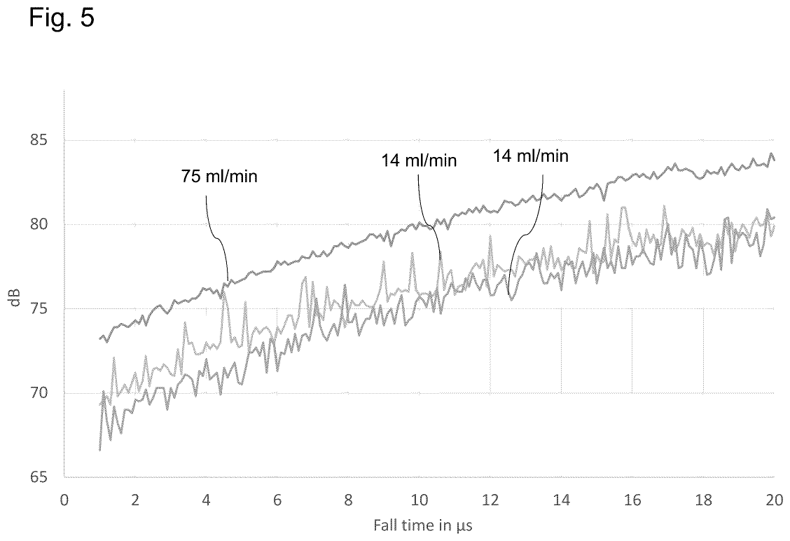

FIG. 5 shows a sound level in dB as a function of a varying fall time of the voltage profile 107 for different flow rates. The voltage profiles 107 used have a constant waiting time of 2.3 μs and a constant rise time of 1 μs. The repetition rate is 15 kHz. The fall time of the voltage profile 107, on the other hand, is changed between 1 μs and 20 μs (X axis).

For example, the printing liquid 109 flows through a circulation head in which the printing liquid 109 continuously circulates through the print head 103 even when no printing liquid 109 is ejected. At a higher flow rate, the volume of the excited print head 103 decreases. In this way, the flow rate of the printing liquid through the print head 103 can be determined by measuring a sound level. An acoustic measurement of the sound level can also be used to detect and correct any deterioration or aging of the piezo elements 101.

Since the print head 103 additionally heats by driving the piezo elements 101, the flow rate of the printing liquid 109 can also be detected by the detected temperature or the changed current flow through the piezo elements 101. The temperature can be detected by an internally installed temperature sensor. The current flow can be detected by an amperemeter or a suitable electrical circuit. In general, the sound level correlates with the current flow through the piezo elements 101 of the print head 103, meaning that when the current flow through the piezo elements 101 is higher, the sound level also increases. In this way, the flow can be measured in the print head 103 even when there are internally linked individual channels, individual nozzles, a row of nozzles, or ink chambers.

For example, if the current flow changes when the piezo elements 101 are driven for a predetermined time, such as 10 min, it means that the flow or temperature is low. The heating of the piezo elements 101 also changes the ejection trajectory or energy absorption.

By means of this technique, the flow rate through the print head 103 can be determined in detail and at specific points. In case of a blockage of the internal filters or channels, a defect can be localized by means of the flow measurement. Therefore, by driving the piezo elements 101 by a voltage profile 107 and measuring the current flow, conclusions can be drawn about the rheology of the printing liquid 109.

Individual piezo elements 101 within the print head 103 can be tested acoustically or by current measurement to determine whether they are functioning properly. If piezo elements 101 fail, the current flow decreases compared to normal operation. In addition, flow measurements of individual print head rows within the print head 103 can be performed.

In addition, differences in the measurement of the current flow through the piezo elements 101 can be seen between different printing liquids 109. In this way, it is possible to rheologically distinguish or characterize the printing liquids 109. Furthermore, an inference can be drawn from the printing liquid 109 to the elasticity.

The test method is based on the fact that due to the lack of flow of the printing liquid 109, there is no energy release or flow that heats the components. This results in the changed current consumption of the piezo elements 101.

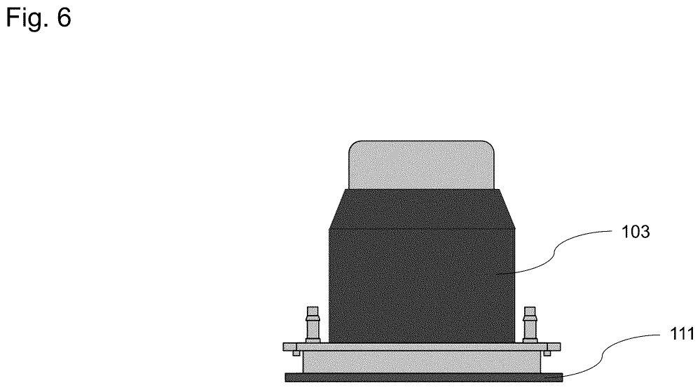

FIG. 6 shows a schematic view of a closure plate 111 for the print head 103. The method can be performed with the printing nozzles 105 open or closed. To close the printing nozzles 105, a closure plate 111 can be used, which is attached to the print head 103.

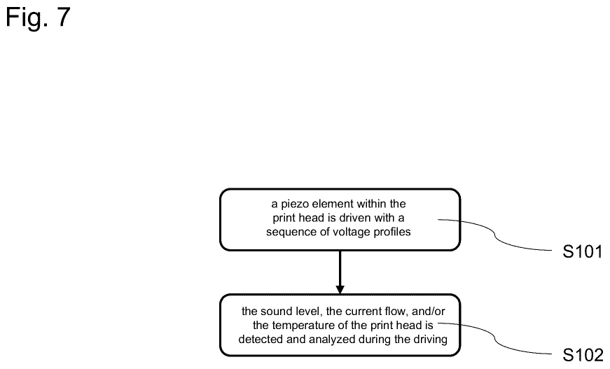

FIG. 7 shows a block diagram of a method for analyzing a print head 103. In step S101, the piezo element 101 within the print head 103 is driven with a sequence of voltage profiles 107. In doing so, in step S102, the sound level, the current flow, and/or the temperature of the print head 103 is detected and analyzed during the driving. By using the method, piezo elements 101 and printing nozzles 105 can be tested for flow or electrical interruption acoustically or by means of a current measurement. The method provides a simple means to determine basic system parameters and to analyze, characterize, or verify the printing liquid 109, the print head 103, and the fluid system.

The method makes it possible to obtain different parameters from the printing device 100 in order to take countermeasures, if necessary. This can be done automatically in a state in which the print head 103 is covered. This makes it possible to achieve more cost-effective optimization and time savings. Efficient and permanent monitoring of a printing system is performed. Fault detection and maintenance are facilitated. In addition, there is the possibility of remote diagnosis, a cost saving in the manufacture of the printing device 100 and a higher process reliability.

All of the features explained and shown in connection with individual embodiments of the invention may be provided in different combinations in the subject matter of the invention to simultaneously realize their beneficial effects.

All method steps can be implemented by devices which are suitable for executing the respective method step. All functions that are executed by the features of the subject matter can be a method step of a method.

The scope of protection of the present invention is given by the claims and is not limited by the features explained in the description or shown in the figures.

### REFERENCE LIST

100 Printing device
101 Piezo element
103 Print head
105 Printing nozzle
107 Voltage profile
109 Printing liquid
111 Closure plate
113 Object
115 Liquid drop
117 Ink chamber
119 Building platform
121 Start section
123 Hold section
125 End section

1. A method for analyzing a print head, comprising the steps of:
driving a piezo element within the print head with a sequence of voltage profiles; and
detecting a sound level, a current flow, a resistance, an impedance, and/or a temperature of the print head during the driving.

2. The method as claimed in claim 1,
wherein the pint head comprises a printing nozzle,
wherein a malfunction of the printing nozzle is detected when the detected sound level, the current flow, or the temperature is above a predetermined value.

3. The method as claimed in claim 1,
wherein the piezo element is excited over a predetermined period of time.

4. The method as claimed in claim 1,
wherein the sequence of the voltage profiles comprises a predetermined sequence of the voltage profiles different from one another.

5. The method as claimed in claim 4,
wherein a hold time, rise time and/or fall time of the voltage profiles increases or decreases in sequence.

6. The method as claimed in claim 1,
wherein a course of the current flow or the temperature of the print head is detected during the driving.

7. The method as claimed in claim 6,
wherein the detected course is compared with a pre-stored course.

8. The method as claimed in claim 7,
wherein the type of a printing liquid inside the print head is determined or characterized based on the comparison.

9. The method as claimed in claim 1,
wherein the sequence of the voltage profiles comprises a predetermined sequence of the voltage profiles equal to one another.

10. The method as claimed in claim 1,
wherein detachment of a nozzle plate is detected when the current flow falls below a predetermined value.

11. The method as claimed in claim 1,
wherein wear of the piezo element (101) is detected when the detected sound level or current flow falls below a predetermined value.

12. The method as claimed in claim 1,
wherein the method is performed when printing liquid in the print head is changed.

13. The method as claimed in claim 1,
wherein the pint head comprises a printing nozzle, and
wherein the printing nozzle is open or closed during the method.

14. The method as claimed in claim 13,
wherein the print head is covered by a closure plate.

15. A printing device, which is configured to carry out the method as claimed in claim 1.
